(19) United States
(12) Patent Application Publication
(10) Pub. No.: US 2026/0141905 A1
(43) Pub. Date: May 21, 2026

(54) REVERBERATION DECORRELATION FOR AMBISONICS AUDIO COMPRESSION

(71) Applicant: GOOGLE LLC, Mountain View, CA (US)

(72) Inventors: Jyrki Antero Alakuijala, Wollerau (CH); Sami Boukortt, Zurich (CH); Moritz Firsching, Basel (CH); Martin Bruse, Tyreso (SE); Evgenii Kliuchnikov, Thalwil (CH); Thomas Fischbacher, Gattikon (CH); Zoltan Szabadka, Gyorujbarat (HU); Matthew Sharifi, Kilchberg (CH)

(21) Appl. No.: 19/104,594

(22) PCT Filed: Sep. 28, 2023
(86) PCT No.: PCT/US2023/075412

§ 371 Date: Feb. 18, 2025

Related U.S. Application Data
(60) Provisional application No. 63/377,668, filed on Sep. 29, 2022.

(51) Int. Cl. G10L 19/008; H04S 7/00

(52) U.S. Cl. CPC G10L 19/008; H04S 7/30; H04S 2420/11

(57) ABSTRACT

A method including receiving an audio signal including a plurality of audio channels, selecting a first portion of the plurality of audio channels, selecting a second portion of the plurality of audio channels, generating first mixed audio channels by mixing the first portion of the plurality of audio channels with a first time-delayed audio channel, generating second mixed audio channels by mixing the second portion of the plurality of audio channels with a second time-delayed audio channel, and generating an augmented ambisonics model based on the plurality of audio channels, the first mixed audio channels, and the second mixed audio channels.

### CROSS REFERENCE TO RELATED APPLICATION

This application claims the benefit of U.S. Provisional Application No. 63/377,668, filed Sep. 29, 2022, the disclosure of which is incorporated herein by reference in its entirety.

### FIELD

Embodiments relate to compressing ambisonic audio.

### BACKGROUND

Ambisonic audio modeling can map audio signals having several directions into spherical harmonics having multiple channels. At least one benefit of the ambisonic audio modeling approach is that every channel may have a substantial number of N audio signals. In an analog processing unit, noise accumulates, on the average, the same amount as the N audio signals which can be problematic when processing the N audio signals.

### SUMMARY

In a general aspect, a device, a system, a non-transitory computer-readable medium (having stored thereon computer executable program code which can be executed on a computer system), and/or a method can perform a process with a method including receiving an audio signal including a plurality of audio channels, selecting a first portion of the plurality of audio channels, selecting a second portion of the plurality of audio channels, generating first mixed audio channels by mixing the first portion of the plurality of audio channels with a first time-delayed audio channel, generating second mixed audio channels by mixing the second portion of the plurality of audio channels with a second time-delayed audio channel, and generating an augmented ambisonics model based on the plurality of audio channels, the first mixed audio channels, and the second mixed audio channels.

Some implementations are directed to generating an augmented ambisonic model (e.g., sound source) without using entropy for coding reflections and reverberations on their respective channels. In an example implementation, reflections and reverberations between channels can be decorrelated by processing subsets of channels in an input or raw ambisonic model (e.g., an ambisonic recording).

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates a block diagram of a data flow according to an example implementation.

FIG. 2 illustrates a pictorial diagram of a data flow according to an example implementation.

FIG. 3 illustrates a block diagram of a method of generating an augmented ambisonics model according to an example implementation.

FIG. 4 illustrates a block diagram of a system according to an example implementation.

FIG. 5 illustrates a block diagram of a method of generating an augmented ambisonics model according to an example implementation.

It should be noted that these Figures are intended to illustrate the general characteristics of methods, and/or structures utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Ambisonic audio modeling can include a plurality of channels each including a number of audio signals. The audio signals associated with each of the plurality of channels can include the reflections and the reverberations between channels. Therefore, as the number of channels increases, the reflections and the reverberations can cause the number of audio signals that should be processed to increase substantially. Decorrelating the reflections and the reverberations between channels can significantly reduce the number of audio signals to be processed.

The decorrelating of reflections and reverberations can have several technical benefits for, for example, a user experience. As a specific example, decorrelating reflections and reverberations between channels by processing subsets of channels can reduce the number of audio signals to be processed while minimizing the impact of decorrelation on the user experience. In other words, audio signal processing can be reduced while a user listening to reconstructed audio hears and/or feels the reflections and the reverberations associated with the ambisonic audio.

Example implementations described herein can decorrelate audio reflections which can include diffusion, reverberation, and sound echo. Diffusion can be the scattering of audio energy. Reverberation can include reflected sound that causes numerous reflections to build up and then decay as the sound is absorbed by the surfaces of objects in the space. Echo can include sound from a speaker reflected back into a microphone. Early reflections can be echoes of the direct sound source, rather than diffuse mixtures as are present in the late reflections, or reverberation, or a sound source. A late reverberation (sometimes called a reverb tail) can be when a reflection embeds the original sound into a soundscape and can render the soundscape indistinct if the reverberation is strong enough. Ambisonic modeling with spherical harmonics may not capture early reflections (e.g., 100-150 ms) and/or longer late reverberations (approximately 1.5 seconds).

The number of audio signals to be processed per channel can be based on the number of components used to represent a sound field. In ambisonics, the sound field can be decomposed into spherical harmonic components (e.g., termed W, X, Y and Z). The spherical harmonic components can collectively be called B-Format. Higher-order ambisonics can include more channels (e.g., greater than 4) than B-Format. B-Format and higher-order ambisonic recordings can be raw ambisonic recordings. Accordingly, higher-order ambisonics with multiple audio signals associated with audio reflections can require significant resources to process. Therefore, using decorrelation in higher-order ambisonics can reduce processing resources.

Processing higher-order ambisonics can include audio compression. When compressing ambisonic audio, each channel can be sampled and windowed, the signals of which can be separately transformed via, for example, a modified discrete cosine transform (MDCT) after windowing to obtain the transformed data for frame being compressed. Compression decorrelations (e.g., source signal is transformed into multiple output signals) that can occur in each audio channel in audio compression can limit the window of compression (e.g., 20 ms). Because of these two phenomena, reflections and reverberations (e.g., correlations between the channels) may not be decorrelated in existing ambisonics compression techniques. Therefore, example implementations, describe decorrelate audio reflections and reverberations for use with higher-order ambisonics audio compression.

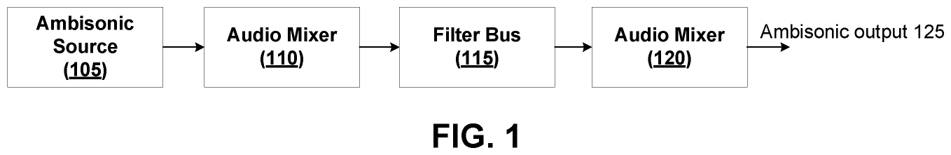

FIG. 1 illustrates a block diagram of a data flow according to an example implementation. As shown in FIG. 1, the data flow includes an ambisonic source 105 block, an audio mixer 110 block, a filter bus 115 block, an audio mixer 120 block, and an ambisonic output 125.

The ambisonic source 105 can be an ambisonic microphone. The ambisonic microphone can include a plurality of sensors pointed in different directions. The ambisonic microphone can capture audio signals in an arrangement based on a raw ambisonic model (e.g., ambisonic pre-reverberation model). The raw ambisonic model can be defined as an audio source based on polygons on a geodesic polyhedron such as an icosahedron, geodesic polyhedrons subdivision or other (geodesic) polyhedra, and/or point sources. Each point on the polygon can correspond to an audio channel of the ambisonic source 105. Therefore, the ambisonic source 105 can have N audio channels. If the ambisonic model is based on a geodesic polyhedron, the ambisonic source 105 can have, for example, 12 audio channels.

The audio mixer 110 can be configured to mix a portion of the N audio channels. The mixing can be a linear mix of ambisonic channels. In an example implementation, the audio mixer 110 can be communicatively coupled to a portion of the N audio channels. Therefore, the audio mixer 110 can be configured to mix audio signals associated with the corresponding communicatively coupled audio channels.

The filter bus 115 can be a ring-buffered filter bus. The filter bus 115 can be configured to reduce the amount of filtering needed to produce a reverberation. The reverberation can be determined (e.g., calculated) using a Tensor Processing Unit(s) (TPU), a graphics processing unit(s) (GPU), and/or a central processing unit(s) (CPU). A ring-buffered filter bus can contain t seconds (e.g., one second, two seconds, three seconds, five seconds, and the like) of audio in a ring buffer form. Each filter bus channel gets its input as the linear mix of ambisonic channels, as generated by the audio mixer 110. In addition, the audio mixer 110 can be communicatively coupled to the filter bus 115 forming a feedback loop. Therefore, the audio mixer 110 can receive a time-delayed channel associated with the filter bus 115. The filter bus 115 signal(s) can be copies of the ambisonic channels, but with filtering applied to the signal(s). The filters can include, for example, low-pass and high-pass filters, notch-filters and the like. Channels in the filter bus 115 can also mix, in the audio mixer 110, time-delayed data from the ring-buffered filter bus, both intra-and inter-channel, allowing for complex infinite impulse response (IIR) type reverberation. In an example implementation, the complexity in computation by the filter bus 115 and the audio mixer 110 can be minimized by limiting the number of channel-to-channel interactions as well as intra-channel interactions with time-delays.

The audio mixer 120 can be configured to mix audio channels from the ambisonic source 105 and/or channels from the filter bus 115. The audio mixer 120 can be configured to generate an augmented ambisonic model as the ambisonic output 125. Each channel in the augmented ambisonic model can be a raw ambisonic model channel mixed with (time-delayed versions) of ring-buffered filter bus channels. This allows for an entropy source (e.g., sound source) to be coded on one of the channels and the channels early reflections and reverberations can occur naturally in the augmented model without entropy used for codifying the early reflections and reverberations on their respective channels. The ambisonic output 125 (e.g., the augmented ambisonic model) can be defined substantially similar to the ambisonic source 105 (e.g., raw ambisonic model). Therefore, ambisonic output 125 (e.g., the augmented ambisonic model) can be defined as an audio source based on polygons on a geodesic polyhedron such as an icosahedron, geodesic polyhedrons subdivision or other (geodesic) polyhedra, and/or point sources.

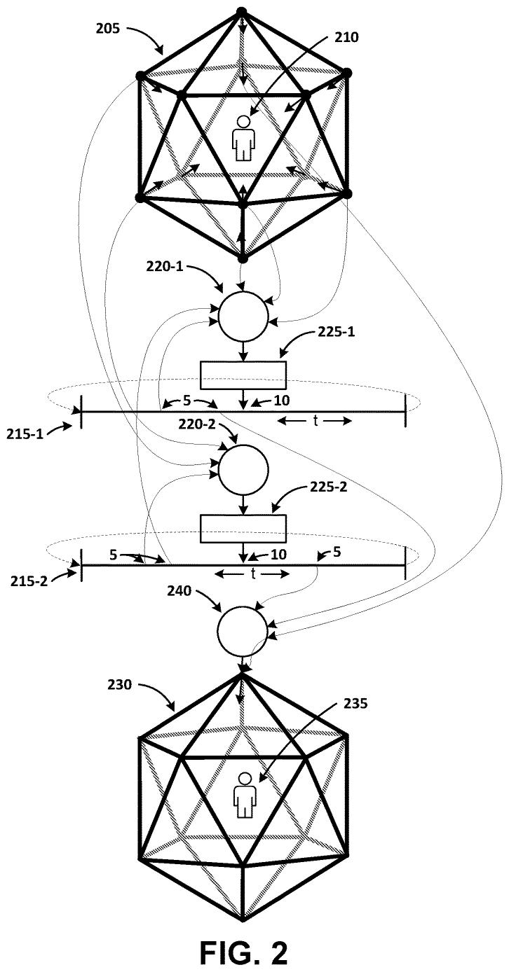

FIG. 2 illustrates a pictorial diagram of a data flow according to an example implementation. As shown in FIG. 2, the data flow can include a raw ambisonic model 205, a mixer 220-1, a mixer 220-2, a filter 225-1, a filter 225-2, a ring-buffered filter bus 215-1, a ring-buffered filter bus 215-2, and an augmented ambisonic model 230.

In the example implementation of FIG. 2, the raw ambisonic model 205 includes N audio channels. The audio channels can be represented by dots at the line intersections in the geodesic polyhedron representing the raw ambisonic model 205. Each channel has an arrow representing an audio direction with respect to a user 210. In each direction, planar waves can be propagating from evenly spaced directions. The mixer 220-1 and the mixer 220-2 can be communicatively coupled with a portion of the N audio channels. For example, the mixer 220-1 is shown as being communicatively coupled with three (3) channels of the N channels and the mixer 220-2 is shown as being communicatively coupled with two (2) channels of the N channels.

The ring-buffered filter bus 215-1, 215-2 can include a timestep (shown as t in FIG. 2) over which a timestep of t seconds (e.g., one second, two seconds, three seconds, five seconds, and the like) of audio in a ring buffer form (as represented by the dotted line left to right). A bus buffer is a circuit whose I/O pins can be configured as input and output to receive and transmit data. A ring buffer (also known as a circular buffer or a circular queue) can be a buffer data structure that operates as if it had a circular shape. For example, the last element in the buffer can be connected to the first element. In audio processing, a filter can be configured to amplify or attenuate an audio signal over a frequency range. Therefore, a ring-buffered filter bus can be a buffer with I/O that pins can be configured as input and output to receive and transmit data operating as an audio signal bus with a filter associated with the audio channel. The ring-buffered filter bus 215-1, 215-2 can be considered a channel of a ring-buffered filter bus.

Arrow 10 can represent a write operation with the arrow direction indicating a direction of data flow (e.g., source to destination). In some implementations, the output of the filter 225-1, 225-2 can be written over the timestep t. Two or more time-delayed channels can be read from the timestep t. The two or more time-delayed channels can be communicatively coupled to the or more time-delayed channels forming a feedback loop. Further, the two or more time-delayed channels can be communicatively coupled to the mixer 240. Arrow 5 can represent a read operation with the arrow direction indicating a direction of data flow (e.g., source to destination). In some implementations, the two or more time-delayed channels can be read and used in the generation of the augmented ambisonic model 230. A portion of the N audio channels can be communicatively coupled to the mixer 240 and/or the augmented ambisonic model 230. The portion of the N audio channels can be used in the generation of the augmented ambisonic model 230. In the augmented ambisonic model 230 every direction can be augmented with signals from the ring-buffered filter bus 215-1, 215-2.

The raw ambisonic model 205 can be defined as an audio source based on polygons on a geodesic polyhedron such as an icosahedron, geodesic polyhedrons subdivision or other (geodesic) polyhedra, and/or point sources. Each point on the polygon can correspond to an audio channel of an audio source (e.g., an ambisonic microphone). Therefore, the raw ambisonic model 205 can have N audio channels. If the ambisonic model is based on a geodesic polyhedron (as shown in FIG. 2), the raw ambisonic model 205 can have, for example, 12 audio channels.

The ring-buffered filter bus 215-1 and the second ring-buffered filter bus 215-2 can be configured to reduce the amount of filtering needed to produce a reverberation. Each filter bus channel gets its input as the linear mix of ambisonic channels, as generated by the mixer 220-1, 220-2 (e.g., a linear mix of ambisonic channels). Mixing parameters can be communicated and interpolated every t seconds.

For example, additional commands can be used to manipulate the ring-buffered filter bus 215-1, 215-2. For example, changing a read position index may ramp down the read during a short time window (e.g., 50 ms) and ramp up the new read position during the same time (e.g., by cross-fading the reads). In some examples, parameter changes can be implemented in a reverberation model for scene changes by erasing the contents or reducing the absolute values of the stored values. Parameters of the filters for the ring-buffered filter bus 215-1, 215-2 can be dynamically changed and the ring-buffered filter bus 215-1, 215-2 can interpolate the parameters during operation.

In addition, the mixer 220-1, 220-2 can be communicatively coupled to the ring-buffered filter bus 215-1, 215-2 forming a feedback loop. In other words, the mixer 220-1, 220-2 can be configured to receive an output audio signal from the ring-buffered filter bus 215-1, 215-2, mix the audio signal with an audio signal of the raw ambisonic model 205 to be used as input to the ring-buffered filter bus 215-1, 215-2. An audio mixer can be configured to receive audio from multiple sources, combine the audio, and output the combined audio. In some implementations, mixing audio signals can include processing the audio signals to adjust (e.g., volume balance) the audio signals.

Accordingly, the mixer 220-1, 220-2 can (and/or be configured to) receive a time-delayed channel from the ring-buffered filter bus 215-1, 215-2. The ring-buffered filter bus 215-1, 215-2 signal(s) can be copies of the ambisonic channels, but with filtering applied to the signal(s). The filters 225-1, 225-2 can include, for example, low-pass and high-pass filters, notch-filters and the like. Channels in the ring-buffered filter bus 215-1, 215-2 can also mix, in the mixer 220-1, 220-2, time-delayed data from the ring-buffered filter bus, both intra-and inter-channel, allowing for complex infinite impulse response (IIR) type reverberation. In an example implementation, the complexity in computation by the ring-buffered filter bus 215-1, 215-2 and the mixer 220-1, 220-2 can be minimized by limiting the number of channel-to-channel interactions as well as intra-channel interactions with time-delays. Although two ring-buffered filter buses 215-1, 215-2 and two mixers 220-1, 220-2 are shown and described, more than two ring-buffered filter buses 215-1, 215-2 and two mixers 220-1, 220-2 are within the scope of this disclosure.

Mixer 240 can be configured to mix audio channels from the raw ambisonic model 205 and/or channels from the ring-buffered filter bus 215-1, 215-2. The mixer 240 can be configured to generate the augmented ambisonic model 230. Each channel in the augmented ambisonic model 230 can be a raw ambisonic model channel mixed with (time-delayed versions) of ring-buffered filter bus channels. This allows for an entropy source (e.g., sound source) to be coded on one of the channels and the channels early reflections and reverberations can occur naturally in the augmented model without entropy used for codifying the early reflections and reverberations on their respective channels. The augmented ambisonic model 230 can be defined substantially similar to the raw ambisonic model 205. Therefore, the augmented ambisonic model 230 can be defined as an audio source based on polygons on a geodesic polyhedron such as an icosahedron, geodesic polyhedrons subdivision or other (geodesic) polyhedra, and/or point sources.

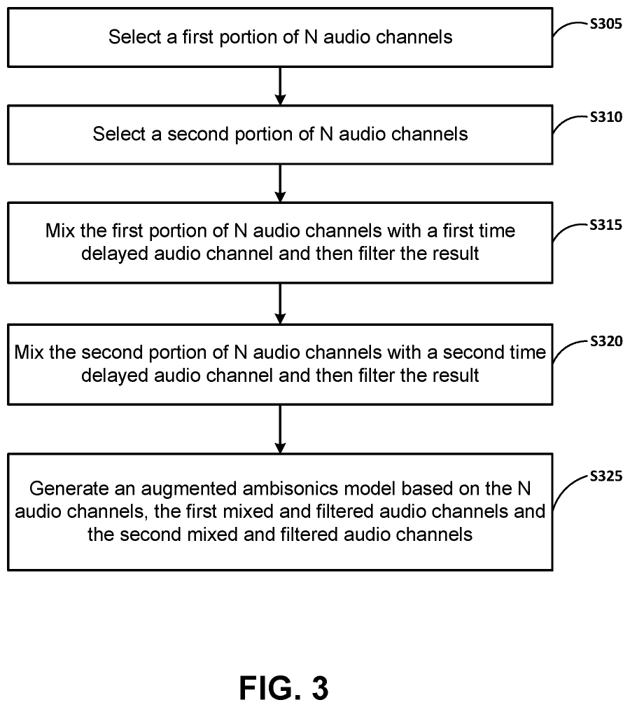

FIG. 3 illustrates a block diagram of a method according to an example implementation. As shown in FIG. 3, in step S305 a first portion of N audio channels is selected. In step S310 a second portion of the N audio channels is selected. The quantity of N audio channels forming the first portion of N audio channels and the second portion of N audio channels can be a design choice. For example, the quantity of N audio channels forming the first portion of N audio channels and the second portion of N audio channels can be a quantity of ring-buffered filter buses 215-1, 215-2 used. N can be based on the ambisonic model 205. Each filter bus channel gets its input as the linear mix of ambisonics channels, as generated by the mixer 220-1, 220-2 (e.g., a linear mix of ambisonics channels).

In step S315 the first portion of N audio channels are mixed with a first time delayed audio channel and then the result is filtered. In step S320 the second portion of N audio channels are mixed with a second time delayed audio channel and then the result is filtered.

In step S325 an augmented ambisonics model is generated based on the N audio channels, the first mixed and filtered audio channels and the second mixed and filtered audio channels. Each channel in the augmented ambisonics model can be a raw ambisonics model channel mixed with (time-delayed versions) of ring-buffered filter bus channels. This allows for an entropy source (e.g., sound source) to be coded on one of the channels and the channels early reflections and reverberations can occur naturally in the augmented model without entropy used for codifying the early reflections and reverberations on their respective channels.

An advantage of the example implementations described herein can be that a more compact (e.g., 10x less bits for the same quality of experience) ambisonics format can be built, because the signals can be decorrelated to larger extent before entropy coding.

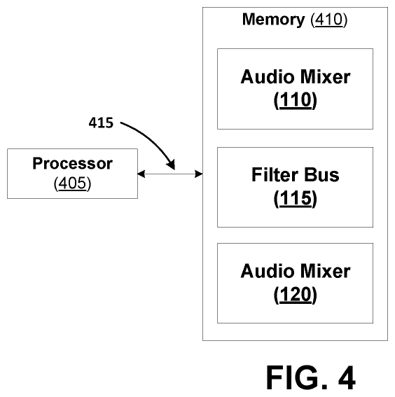

FIG. 4 illustrates a block diagram of a system according to an example implementation. In the example of FIG. 4, the system (e.g., an audio compression system, an audio streaming system, an audio storage system, and the like.) can include a computing system or at least one computing device and should be understood to represent virtually any computing device configured to perform the techniques described herein. As such, the device may be understood to include various components which may be utilized to implement the techniques described herein, or different or future versions thereof. By way of example, the system can include a processor 405 and a memory 410 (e.g., a non-transitory computer readable memory). The processor 405 and the memory 410 can be coupled (e.g., communicatively coupled) by a bus 415.

The processor 405 may be utilized to execute instructions stored on the at least one memory 410. Therefore, the processor 405 can implement the various features and functions described herein, or additional or alternative features and functions. The processor 405 and the at least one memory 410 may be utilized for various other purposes. For example, the at least one memory 410 may represent an example of various types of memory and related hardware and software which may be used to implement any one of the modules described herein.

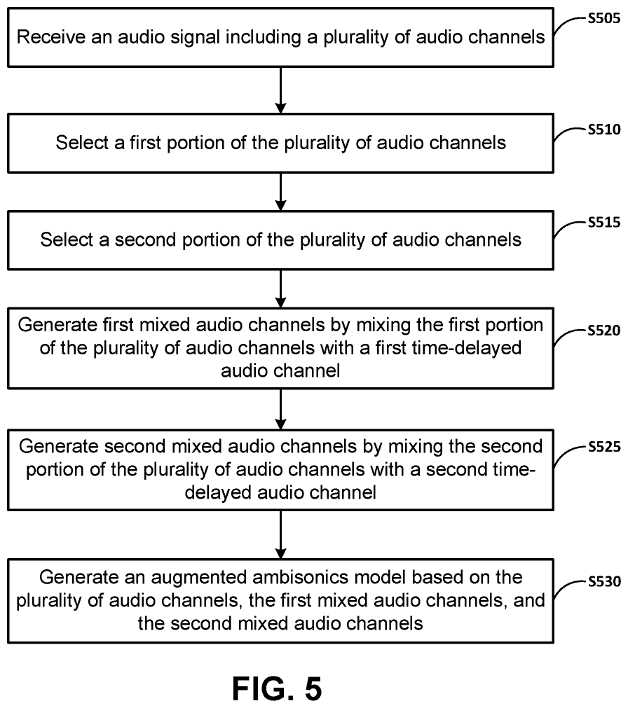

The at least one memory 410 may be configured to store data and/or information associated with the device. The at least one memory 410 may be a shared resource. Therefore, the at least one memory 410 may be configured to store data and/or information associated with other elements (e.g., image/video processing or wired/wireless communication) within the larger system. Together, the processor 405 and the at least one memory 410 may be utilized to implement the techniques described herein. As such, the techniques described herein can be implemented as code segments (e.g., software) stored on the memory 410 and executed by the processor 405. Accordingly, the memory 410 can include the audio mixer 110, the filter bus 115, and the audio mixer 120 each described in more detail above.
Example 1. FIG. 5 is a block diagram of a method of generating an augmented ambisonics model according to an example implementation. As shown in FIG. 5, in step S505 receive an audio signal including a plurality of audio channels. In step S510 select a first portion of the plurality of audio channels. In step S515 select a second portion of the plurality of audio channels. In step S520 generate first mixed audio channels by mixing the first portion of the plurality of audio channels with a first time-delayed audio channel. For example, in some implementations all channels of the respective portions can be mixed with the time-delayed version. For example, in some implementations a subset of channels can be mixed with the time-delayed version. For example, in some implementations the channels of a portion can be mixed together with the time-delayed version.

In step S525 generate second mixed audio channels by mixing the second portion of the plurality of audio channels with a second time-delayed audio channel. In step S530 generate an augmented ambisonics model based on the plurality of audio channels, the first mixed audio channels, and the second mixed audio channels. In some implementations, the plurality of audio channels can be buffered and i) the first time-delayed audio channel can be a version of one of the plurality of buffered audio channels delayed about a predetermined time and ii) the second time-delayed audio channel can be a version of another one of the plurality of buffered audio channels delayed about the same time.
Example 2. The method of Example 1, wherein the generating of the first mixed audio channels can further include filtering the first portion of the plurality of audio channels mixed with the first time-delayed audio channel as a filtered first mixed audio channels and the generating of the second mixed audio channels can further include filtering the second portion of the plurality of audio channels mixed with the second time-delayed audio channel as a filtered second mixed audio channels.
Example 3. The method of Example 2, wherein the first time-delayed audio channel can be selected from a ring-buffered filter bus having a timestep of the filtered first mixed audio channels. In some implementations, the audio signals can be time associated with stamped audio signals corresponding to audio channels (or portions of audio channels). A time stamp can correspond to a point in time that an audio sensing device (e.g., a microphone) senses, captures, records, and the like an audio. In some implementations, these audio channels can be mixed audio channels portion of the dataflow. In some implementations, these audio channels can be stored in a ring-buffered filter (in memory). In some implementations, audio channels associated with the same time stamp (e.g., recorded at the same time) should be processed together. Therefore, in some implementations when processing an audio channel associated with the mixed audio channels and with the ring-buffered filter bus, data having the same time stamp of each should be selected.
Example 4. The method of Example 2, wherein the second time-delayed audio channel can be selected from a ring-buffered filter bus having a timestep of the filtered second mixed audio channels. In some implementations, the audio signals can be time associated with stamped audio signals corresponding to audio channels (or portions of audio channels). A time stamp can correspond to a point in time that an audio sensing device (e.g., a microphone) senses, captures, records, and the like an audio. In some implementations, these audio channels can be mixed audio channels portion of the dataflow. In some implementations, these audio channels can be stored in a ring-buffered filter (in memory). In some implementations, audio channels associated with the same time stamp (e.g., recorded at the same time) should be processed together. Therefore, in some implementations when processing an audio channel associated with the mixed audio channels and with the ring-buffered filter bus, data having the same time stamp of each should be selected.
Example 5. The method of Example 1, wherein a first ring filter can be used to filter the first portion of the plurality of audio channels, and a second ring filter can be used to filter the second portion of the plurality of audio channels, the method can further include at least one of changing a read position index on the first ring filter and the second ring filter.
Example 6. The method of Example 1, wherein the audio signal can be associated with a source (e.g., a microphone grouping) arranged based on a raw ambisonic model defined as an audio source based on polygons on a geodesic polyhedron.
Example 7. The method of Example 1, wherein the generating of the augmented ambisonics model can include a linear mixing of the plurality of audio channels, the first mixed audio channels, and the second mixed audio channels.
Example 8. A method can include any combination of one or more of Example 1 to Example 7.
Example 9. A non-transitory computer-readable storage medium comprising instructions stored thereon that, when executed by at least one processor, are configured to cause a computing system to perform the method of any of Examples 1-8.
Example 10. An apparatus comprising means for performing the method of any of Examples 1-8.
Example 11. An apparatus comprising at least one processor and at least one memory including computer program code, the at least one memory and the computer program code configured to, with the at least one processor, cause the apparatus at least to perform the method of any of Examples 1-8.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. The components shown here, their connections and relationships, and their functions, are meant to be examples only, and are not meant to limit implementations of the inventions described and/or claimed in this document.

A number of embodiments have been described. Nevertheless, it will be understood that various modifications may be made without departing from the spirit and scope of the specification. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A method comprising:
receiving an audio signal including a plurality of audio channels;
selecting a first portion of the plurality of audio channels;
selecting a second portion of the plurality of audio channels;
generating first mixed audio channels by mixing the first portion of the plurality of audio channels with a first time-delayed audio channel;
generating second mixed audio channels by mixing the second portion of the plurality of audio channels with a second time-delayed audio channel; and
generating an augmented ambisonics model based on the plurality of audio channels, the first mixed audio channels, and the second mixed audio channels.

2. The method of claim 1, wherein:
the generating of the first mixed audio channels further includes filtering the first portion of the plurality of audio channels mixed with the first time-delayed audio channel as a filtered first mixed audio channels; and
the generating of the second mixed audio channels further includes filtering the second portion of the plurality of audio channels mixed with the second time-delayed audio channel as a filtered second mixed audio channels.

3. The method of claim 2, wherein the first time-delayed audio channel is selected from a ring-buffered filter bus having a timestep of the filtered first mixed audio channels.

4. The method of claim 2, wherein the second time-delayed audio channel is selected from a ring-buffered filter bus having a timestep of the filtered second mixed audio channels.

5. The method claim 2, wherein
a first ring filter is used to filter the first portion of the plurality of audio channels, and
a second ring filter is used to filter the second portion of the plurality of audio channels, the method further comprising at least one of changing a read position index on the first ring filter and the second ring filter.

6. The method of claim 1, wherein the audio signal is associated with a source arrangement based on a raw ambisonic model defined as an audio source based on polygons on a geodesic polyhedron.

7. The method of claim 1, wherein the generating of the augmented ambisonics model includes a linear mixing of the plurality of audio channels, the first mixed audio channels, and the second mixed audio channels.

8. A non-transitory computer-readable storage medium comprising instructions stored thereon that, when executed by at least one processor, are configured to cause a computing system to:
receive an audio signal including a plurality of audio channels;
select a first portion of the plurality of audio channels;
select a second portion of the plurality of audio channels;
generate first mixed audio channels by mixing the first portion of the plurality of audio channels with a first time-delayed audio channel;
generate second mixed audio channels by mixing the second portion of the plurality of audio channels with a second time-delayed audio channel; and
generate an augmented ambisonics model based on the plurality of audio channels, the first mixed audio channels, and the second mixed audio channels.

9. The non-transitory computer-readable storage medium of claim 8, wherein:
the generating of the first mixed audio channels further includes filtering the first portion of the plurality of audio channels mixed with the first time-delayed audio channel as a filtered first mixed audio channels; and
the generating of the second mixed audio channels further includes filtering the second portion of the plurality of audio channels mixed with the second time-delayed audio channel as a filtered second mixed audio channels.

10. The non-transitory computer-readable storage medium of claim 9, wherein the first time-delayed audio channel is selected from a ring-buffered filter bus having a timestep of the filtered first mixed audio channels.

11. The non-transitory computer-readable storage medium of claim 9, wherein the second time-delayed audio channel is selected from a ring-buffered filter bus having a timestep of the filtered second mixed audio channels.

12. The non-transitory computer-readable storage medium of claim 8, wherein the audio signal is in an arrangement based on a raw ambisonic model defined as an audio source based on polygons on a geodesic polyhedron.

13. The non-transitory computer-readable storage medium of claim 8, wherein the generating of the augmented ambisonics model includes a linear mixing of the plurality of audio channels, the first mixed audio channels, and the second mixed audio channels.

14. An apparatus comprising:
at least one processor; and
at least one memory including computer program code;
the at least one memory and the computer program code configured to, with the at least one processor, cause the apparatus to:
receive an audio signal including a plurality of audio channels;
select a first portion of the plurality of audio channels;
select a second portion of the plurality of audio channels;
generate first mixed audio channels by mixing the first portion of the plurality of audio channels with a first time-delayed audio channel;
generate second mixed audio channels by mixing the second portion of the plurality of audio channels with a second time-delayed audio channel; and
generate an augmented ambisonics model based on the plurality of audio channels, the first mixed audio channels, and the second mixed audio channels.

15. The apparatus of claim 14, wherein:
the generating of the first mixed audio channels further includes filtering the first portion of the plurality of audio channels mixed with the first time-delayed audio channel as a filtered first mixed audio channels; and
the generating of the second mixed audio channels further includes filtering the second portion of the plurality of audio channels mixed with the second time-delayed audio channel as a filtered second mixed audio channels.

16. The apparatus of claim 15, wherein the first time-delayed audio channel is selected from a ring-buffered filter bus having a timestep of the filtered first mixed audio channels.

17. The apparatus of claim 15, wherein the second time-delayed audio channel is selected from a ring-buffered filter bus having a timestep of the filtered second mixed audio channels.

18. The apparatus of claim 15, wherein
a first ring filter is used to filter the first portion of the plurality of audio channels, and
a second ring filter is used to filter the second portion of the plurality of audio channels, the computer program code is further configured to at least one of changing a read position index on the first ring filter and the second ring filter.

19. The apparatus of claim 14, wherein the audio signal is a raw ambisonic model defined as an audio source based on polygons on a geodesic polyhedron.

20. The apparatus of claim 14, wherein the generating of the augmented ambisonics model includes a linear mixing of the plurality of audio channels, the first mixed audio channels, and the second mixed audio channels.
